(19) United States
(12) Patent Application Publication
(10) Pub. No.: US 2006/0168472 A1
(43) Pub. Date: Jul. 27, 2006

(54) Data storage unit failure condition responding method and system

(75) Inventor: Chih-Wei Chen, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/043,652

(22) Filed: Jan. 25, 2005

(51) Int. Cl. G06F 11/00

(52) U.S. Cl. 714/6

(57) ABSTRACT

A data storage unit failure condition responding method and system is proposed, which is designed for use in conjunction with an access control interface that is coupled between a computer system and a data storage unit for responding to an event of a failure condition in the data storage unit; and which is characterized by the capability of storing all subsequently received access commands into a queuing buffer in the event of a failure condition in the data storage unit and putting the access control interface in a waiting state until the failed data storage unit resumes normal operating condition to process each queued access command, rather than still try to process the access commands and result in unsuccessful access operations as in the case of the prior art. This feature can help ensure the overall network data processing efficiency.

### BACKGROUND OF THE INVENTION

1. Field of the Invention

This invention relates to information technology (IT), and more particularly, to a data storage unit failure condition responding method and system which is designed for use in conjunction with an access control interface that is coupled between a computer system (such as a cluster of servers) and a data storage unit (such as a RAID unit) for responding to an event of a failure condition in the data storage unit (such as in the event that the data storage unit is temporarily disconnected, or undergoes a change in system configuration, to name a few) by performing a special event handling procedure that can help prevent subsequently-received access commands from causing errors in the access operations to the failed data storage unit.

2. Description of Related Art

RAID (Redundant Array of Independent Disks) is a multi-disk storage unit that contains two or more hard disks for providing a very large data storage capacity, and which is connected via a special type of access control interface, such as an FC/iSCSI (Fibre Channel/Internet Small Computer System Interface) compliant interface, to one or more network servers to these servers to gain access to the data stored in the RAID unit via the FC/iSCSI access control interface.

In actual operation of a network system, the RAID unit could be occasionally subjected to a temporary failure condition, such as in the event that the RAID unit is temporarily disconnected, or undergoes a change in system configuration, to name just a few. Under such a failure condition, if the access control interface continues to receive access commands from the servers, then since the failed RAID unit is unable to respond, it will cause an error in the access operation, and as a result, the access control interface will return a retry message to the server, asking the server to try and issue the same access command again. However, since the RAID unit is still in failure condition, the retry process will nevertheless result in an unsuccessful access operation to the failed RAID unit. The repeated retry process will thus consume unnecessary processing time and degrade the overall network data processing efficiency.

### SUMMARY OF THE INVENTION

It is therefore an objective of this invention to provide a data storage unit failure condition responding method and system which is capable of responding a failure condition in a RAID unit by performing a special event handling procedure that can help prevent subsequently-received access commands from causing errors in the access operations to the failed RAID unit so that the overall network data processing efficiency can be ensured.

The data storage unit failure condition responding method and system according to the invention is designed for use in conjunction with an access control interface that is coupled between a computer system (such as a cluster of servers) and a data storage unit (such as a RAID unit) for responding to an event of a failure condition in the data storage unit (such as in the event that the data storage unit is temporarily disconnected, or undergoes a change in system configuration, to name a few) by performing a special event handling procedure that can help prevent subsequently-received access commands from causing errors in the access operations to the failed data storage unit.

The data storage unit failure condition responding method and system according to the invention is characterized by the capability of storing all subsequently-received access commands into a queuing buffer in the event of a failure condition in the data storage unit and putting the access control interface in a waiting state until the failed data storage unit resumes normal operating condition to process each queued access command in the queuing buffer, rather than still try to process the access commands and result in unsuccessful access operations that would consume unnecessary processing time and degrade the overall network data processing efficiency as in the case of the prior art. This feature can help ensure the overall network data processing efficiency.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and modularized object-oriented component model of the data storage unit failure condition responding system according to the invention.

### DETAILED DESCRIPTION OF PREFERRED EMBODIMENTS

The data storage unit failure condition responding method and system according to the invention is disclosed in full details by way of preferred embodiments in the following with reference to the accompanying drawing.

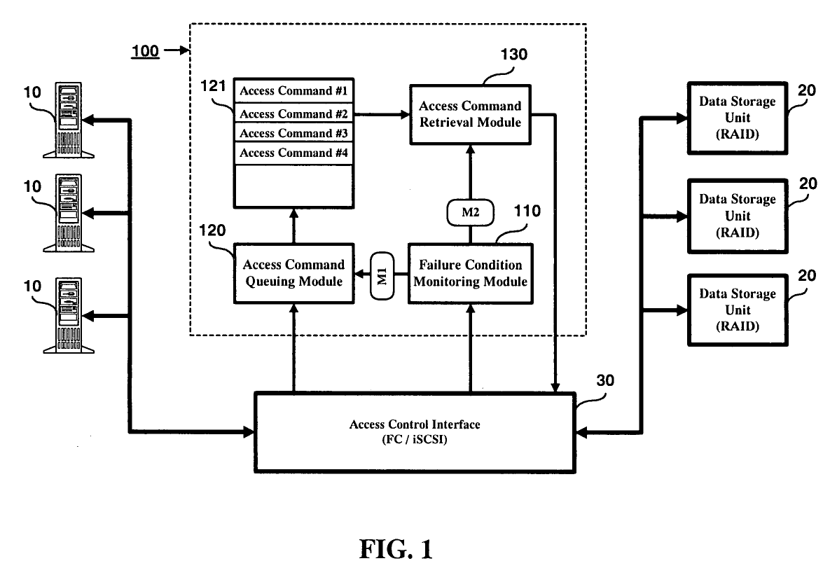

FIG. 1 is a schematic diagram showing the application architecture and modularized object-oriented component model of the data storage unit failure condition responding system according to the invention (as the part enclosed in the dotted box indicated by the reference numeral 100). As shown, the data storage unit failure condition responding system of the invention 100 is designed for use in conjunction with an access control interface 30 that is coupled between at least one computer system 10 (such as a server cluster) and at least one data storage unit (such as a RAID unit) for responding to an event of a failure condition in the data storage unit 20 (such as in the event that the data storage unit 20 is temporarily disconnected, or undergoes a change in system configuration, to name just a few) by performing a special event handling procedure that can help prevent subsequently received access commands from causing errors in the access operations to the failed RAID unit so that the overall network data processing efficiency can be ensured.

In the embodiment of FIG. 1, for example, the access control interface 30 is coupled between a cluster of 3 server units and 3 RAID units for demonstrative purpose only, but in practice, the applicable number of server units and RAID unit is unlimited. Moreover, in practical implementation, for example, the access control interface 30 can be either an FC (Fibre Channel) compliant or an iSCSI (Internet SCSI, where SCSI=Small Computer System Interface) compliant interface. Beside FC/iSCSI implementations, other types of interfaces are also usable.

As shown in FIG. 1, the modularized object-oriented component model of the data storage unit failure condition responding system of the invention 100 comprises: (a) a failure condition monitoring module 110; (b) an access command queuing module 120; and (c) an access command retrieval module 130.

The failure condition monitoring module 110 is capable of monitoring whether a failure condition occurs in any data storage unit 20; and if YES, capable of issuing a queue enabling message M1; and further capable of issuing a normal operating condition notifying message M2 when the failed data storage unit 20 resumes normal operating condition. In practical implementation, for example, the failure condition monitoring module 110 is realized in such a manner that a flag is used to indicate whether the data storage unit 20 is in failure condition or in normal operating condition; i.e., if the data storage unit 20 is in failure condition, the flag is set to [1]; and whereas if the data storage unit 20 is in normal operating condition, the flag is set to [0].

The access command queuing module 120 is equipped with a queuing buffer 121, and which is capable of responding to the queue enabling message M1 from the failure condition monitoring module 110 by putting all subsequently-received access commands into the queuing buffer 121 after the failure condition in one data storage unit 20 occurs.

The access command retrieval module 130 is capable of responding to the normal operating condition notifying message M2 from the failure condition monitoring module 110 to retrieve each access command in the queuing buffer 121 in a prespecified order, such as in FIFO (First In First Out) order, and sending each retrieved access command to the access control interface 30 for the access control interface 30 to execute each access command for data access to the data storage unit 20.

Referring to FIG. 1, in actual operation, if each data storage unit 20 is operating in normal operating condition, the access control interface 30 will process each received access command from the computer system 10 to allow the computer system 10 to gain access to the data storage unit 20. However, in the event of the occurrence of a failure condition in one data storage unit 20, it will cause the failure condition monitoring module 110 to respond to this failure condition by issuing a queue enabling message M1 to the access command queuing module 120, thereby activating the access command queuing module 120 to respond by putting each subsequently-received access command into the queuing buffer 121 after the failure condition in the data storage unit 20 occurs.

Thereafter, as the failed data storage unit 20 resumes normal operating condition, it will then cause the failure condition monitoring module 110 to respond by issuing a normal operating condition notifying message M2 to the access command retrieval module 130, thereby activating the access command retrieval module 130 to respond by retrieving each queued access command from the queuing buffer 121 in a prespecified order, such as in FIFO order, and sending each retrieved access command to the access control interface 30 for the access control interface 30 to execute each access command for data access to the data storage unit 20.

Compared to the prior art, since after the data storage unit 20 fails, the data storage unit failure condition responding system of the invention 100 is capable of responding by storing all subsequently-received access commands into a queuing buffer 121 and putting the access control interface in a waiting state until the data storage unit 20 resumes normal operating condition to process each queued access command in the queuing buffer 121, rather than still try to process the access commands and result in unsuccessful access operations that would consume unnecessary processing time and degrade the overall network data processing efficiency as in the case of the prior art. The data storage unit failure condition responding system of the invention 100 can therefore help to ensure the overall network data processing efficiency.

In conclusion, the invention provides a data storage unit failure condition responding method and system for use with an access control interface that is coupled between at least one computer system and at least one data storage unit for responding to an event of a failure condition in the data storage unit; and which is characterized by the capability of storing all subsequently-received access commands into a queuing buffer in the event of a failure condition in the data storage unit and putting the access control interface in a waiting state until the failed data storage unit resumes normal operating condition to process each queued access command in the queuing buffer, rather than still try to process the access commands and result in unsuccessful access operations that would consume unnecessary processing time and degrade the overall network data processing efficiency as in the case of the prior art. This feature can help ensure the overall network data processing efficiency. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A data storage unit failure condition responding method for use on an access control interface that is coupled between at least one computer system and at least one data storage unit for responding to an event of a failure condition in the data storage unit;
the data storage unit failure condition responding method comprising:
monitoring whether a failure condition occurs in the data storage unit; if YES, issuing a queue enabling message;
responding to the queue enabling message by storing every subsequently-received access command into a queuing buffer;
monitoring whether the failed data storage unit resumes normal operating condition; if YES, issuing a normal operating condition notifying message; and
responding to the normal operating condition notifying message by retrieving each queued access command in the queuing buffer in a prespecified order and sending each retrieved access command to the access control interface for the access control interface to execute each access command for data access to the data storage unit.

2. The data storage unit failure condition responding method of claim 1, wherein the computer system is a server cluster.

3. The data storage unit failure condition responding method of claim 1, wherein the data storage unit is a RAID (Redundant Array of Independent Disks) unit.

4. The data storage unit failure condition responding method of claim 1, wherein the access control interface is an FC/iSCSI (Fibre Channel/Internet Small Computer System Interface) compliant interface.

5. A data storage unit failure condition responding system for use with an access control interface that is coupled between at least one computer system and at least one data storage unit for responding to an event of a failure condition in the data storage unit;
the data storage unit failure condition responding system comprising:
a failure condition monitoring module, which is capable of monitoring whether a failure condition occurs in the data storage unit; if YES, capable of issuing a queue enabling message; and further capable of issuing a normal operating condition notifying message when the failed data storage unit resumes normal operating condition;
an access command queuing module, which is equipped with a queuing buffer, and which is capable of responding to the queue enabling message from the failure condition monitoring module by storing every subsequently-received access command into the queuing buffer; and
an access command retrieval module, which is capable of responding to the normal operating condition notifying message from the failure condition monitoring module by retrieving each queued access command in the queuing buffer in a prespecified order and sending each retrieved access command to the access control interface for the access control interface to execute each access command for data access to the data storage unit.

6. The data storage unit failure condition responding system of claim 5, wherein the computer system is a server cluster.

7. The data storage unit failure condition responding system of claim 5, wherein the data storage unit is a RAID (Redundant Array of Independent Disks) unit.

8. The data storage unit failure condition responding system of claim 5, wherein the access control interface is an FC/iSCSI (Fibre Channel/Internet Small Computer System Interface) compliant interface.
